(19) United States
(12) Patent Application Publication
(10) Pub. No.: US 2006/0219045 A1
(43) Pub. Date: Oct. 5, 2006

(54) Composite steering interface for a bicycle

(75) Inventors: Mark Schroeder, San Jose, CA (US); Christopher P. D'Aluisio, Watsonville, CA (US)

Correspondence Address: MICHAEL BEST & FRIEDRICH, LLP, 100 E WISCONSIN AVENUE, MILWAUKEE, WI, 53202, US

(73) Assignee: Specialized Bicycle Components, Inc., Morgan Hill, CA (US)

(21) Appl. No.: 11/083,907

(22) Filed: Mar. 18, 2005

(51) Int. Cl. B62K 21/12

(52) U.S. Cl. 74/551.1

(57) ABSTRACT

A steering interface for a bicycle including a front fork. The steering interface includes a handlebar formed as a separate component and a stem including an attachment portion and a bar-receiving portion. The attachment portion is adapted to engage the front fork to connect the stem to the bicycle. At least a portion of the bar-receiving portion is formed around a portion of the handlebar such that the handlebar and the stem are integrated into a single component.

### BACKGROUND

The present invention relates to a steering interface for a bicycle. More particularly, the invention relates to a composite bicycle steering interface that includes a stem and a handlebar.

Bicycles generally include a steering interface that allows a rider to steer the bicycle. The steering interface generally includes a handlebar that provides a convenient place for a rider to place his or her hands during a ride and a stem that connects the handlebar to the remainder of the bicycle.

Many different shapes of handlebars are available. The rider typically decides on the shape of the handlebar based on the type of riding in which the rider engages, on rider preference, and/or on the fit for the rider's hand. For example, mountain biking may require a different shaped handlebar when compared to touring or road racing.

In most bicycles, the front fork of the bicycle is rotatable to turn the front wheel. The stem attaches to the front fork at one end and supports the handlebars at the opposite end. In most designs, the stem positions the handlebars away from the steering axis of the front fork.

### SUMMARY

The present invention provides a bicycle steering interface that includes a handlebar and a stem that are integrally formed as a single component. In preferred constructions a composite material is used to form the steering interface. The assembly methods employed generally produce a step between the stem portion and the handlebar portion that gives the appearance that the two components are separate parts. In some constructions the handlebar has a reduced wall thickness when compared to a prior handlebar because the handlebar is no longer subjected to clamping forces from the stem.

The present invention also provides a method of manufacturing a steering interface that includes forming and curing the handlebar and at least partially forming and curing the stem separately. The two portions are then positioned adjacent one another and the stem is completed such that the stem and the handlebar are integrated into a single component. In another construction, the handlebar is formed and cured as a separate component. The material that makes up the lower portion of the stem is positioned within a mold and then the handlebar is positioned within the mold, on top of the material of the lower portion of the stem. The lay-up of the stem is completed and the stem is cured such that the stem and handlebar are integrated into a single component.

### BRIEF DESCRIPTION OF THE DRAWINGS

FIG. 1 is a side view of a bicycle including a steering interface embodying the present invention;

FIG. 2 is a perspective view of the steering interface of FIG. 1 including a stem and a handlebar;

FIG. 3 is an enlarged perspective view of the stem and handlebar of FIG. 2;

FIG. 4 is a partial section view of the stem taken along line 4-4 of FIG. 3;

FIG. 5 is section view of the stem taken along line 5-5 of FIG. 3;

FIG. 6 is a perspective view of a mold suited for use in manufacturing the steering assembly of FIG. 1; and

FIG. 7 is an exploded perspective view illustrating an alternative assembly method; and

FIG. 8 is an exploded perspective view illustrating another alternative assembly method.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

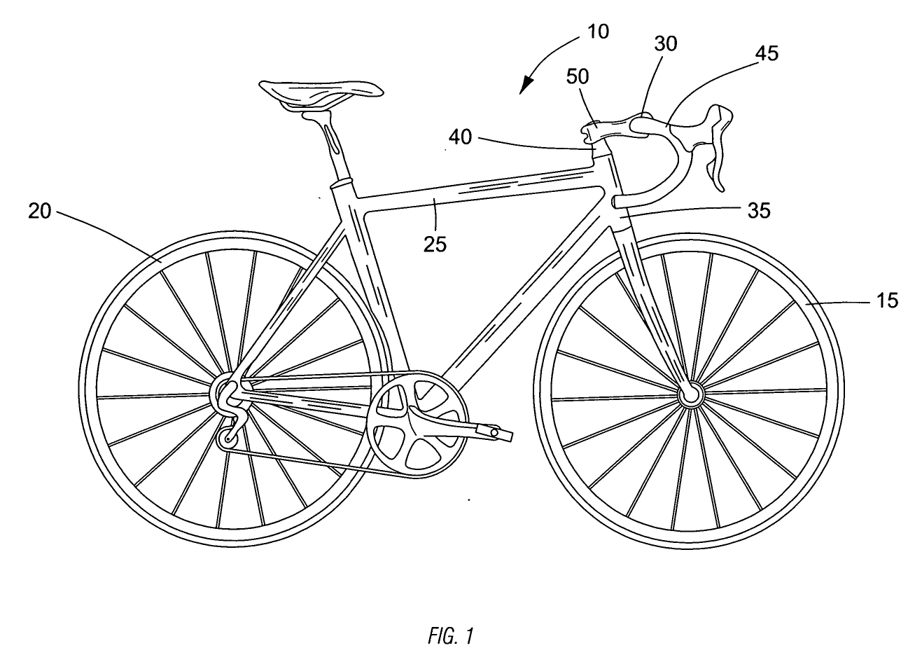

FIG. 1 illustrates a bicycle 10 that includes a front wheel 15, a rear wheel 20, a frame 25, and a steering assembly 30. The frame 25 includes a head tube 35 that engages and supports a front fork 40 for pivotal movement about a steering axis. Generally, the front fork 40 extends through and above the head tube 35 to provide an attachment point for the steering assembly 30. The front fork 40 also supports the front wheel 15 of the bicycle 10 such that movement of the steering assembly 30 produces a corresponding movement of the front wheel 15.

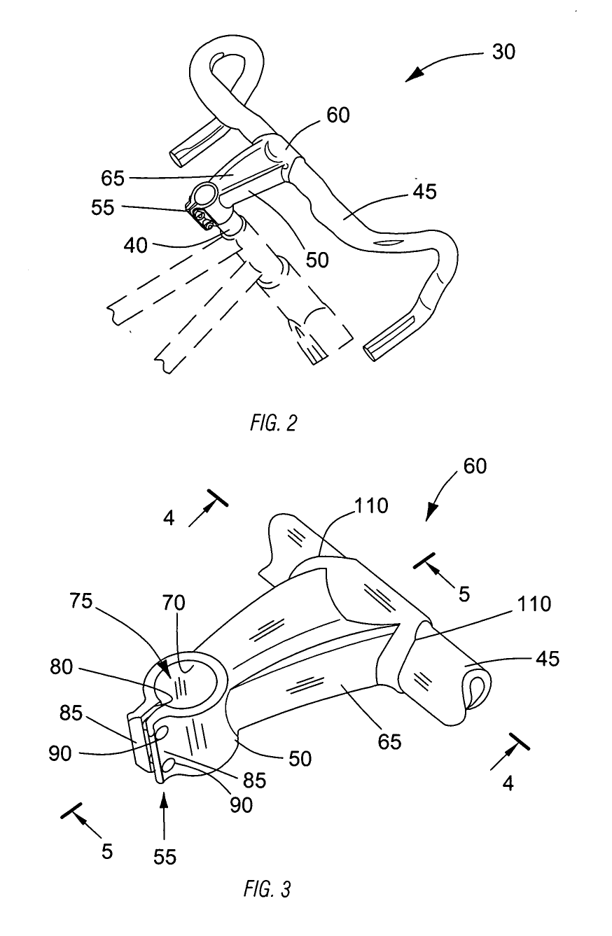

Turning to FIG. 2, the steering assembly 30 is illustrated attached to the top of the front fork 40. The steering assembly 30 includes a handlebar 45 and a stem 50. While the illustrated handlebar 45 is a drop bar, one of ordinary skill in the art will realize that virtually any bar style could be employed with the present invention.

The stem 50 is preferably formed from a composite material such as a carbon/epoxy composite. Of course other materials (e.g., plastics, fiberglass composite, Kevlar composite, or other composites, and the like) could also be employed to form the stem 50. The stem 50 includes a steerer clamp end 55, a handlebar-engaging end 60, and a wall portion 65. The steerer clamp end 55, better illustrated in FIG. 3, includes a substantially cylindrical surface 70 that defines a front fork-receiving opening 75. The cylindrical surface 70 includes a split 80 that extends the length of the cylindrical surface 70 and allows the fork-receiving opening 75 to expand and contract slightly. The steerer clamp end 55 also includes two flanges 85 disposed along either side of the split 80. The flanges 85 extend outward from the cylindrical surface 70 such that they are substantially parallel to one another and extend substantially the full the length of the split 80.

Apertures 90 extend through each flange 85 and align with one another. The apertures 90 provide a space for receiving fasteners that can be employed to reduce the size of the fork-receiving opening 75 such that the cylindrical surface 70 clamps the front fork 40. In the illustrated construction, two apertures 90 extend through each flange 85. However, as one of ordinary skill in the art will realize, a single aperture 90, or three or more apertures 90 and a corresponding number of fasteners could be employed if desired.

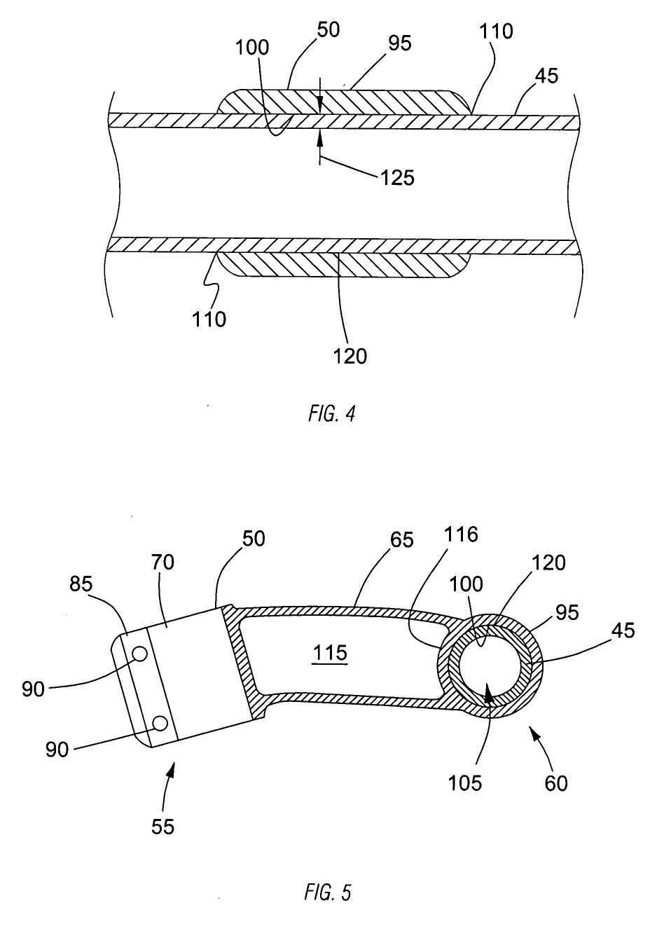

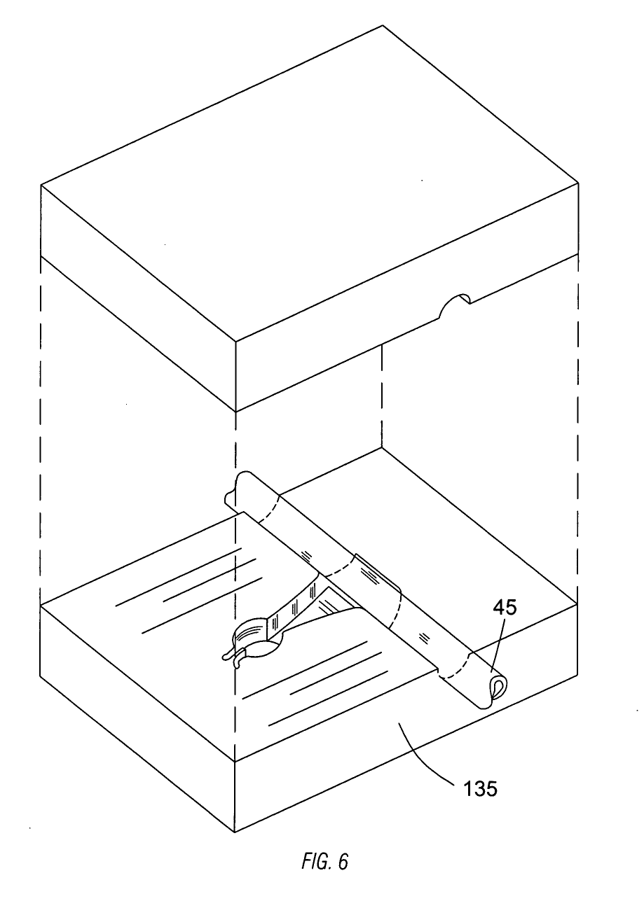

Turning to FIGS. 4 and 5, the handlebar-engaging end 60 includes an outer surface 95 and an inner cylindrical wall 100 that defines a handlebar aperture 105 (shown in FIG. 5) through which the handlebar 45 extends. The outer surface 95 is larger than the handlebar 45 and defines steps 110 (shown in FIG. 4) between the stem 50 and the handlebar 45. It should be noted that FIGS. 4 and 5 illustrate the handlebar 45 as being a separate component from the stem 50. While this is true during the manufacturing process, after manufacturing is complete, there is no separation between the two parts as they are integrated into a single steering interface 30.

As illustrated in FIG. 5, the wall portion 65 interconnects the steerer clamp end 55 and the handlebar-engaging end 60 to complete the stem 50. The wall portion 65 is substantially hollow and defines an interior space 115. The use of a hollow wall portion 65 reduces the weight of the steering interface 30, which in turn reduces the weight of the bicycle 10. The hollow wall portion 65 is optimal for composite lay up, design, and manufacture as it requires less material to manufacture than would a solid stem 50. In some constructions, the interior space 115 is filled with a filler material. For example, plastic or foam can be injected into the space 115 to change some of the mechanical properties of the stem 50 without significantly increasing the weight of the stem 50. In still other constructions, a core, such as a honeycomb core is positioned within the interior space 115 as the stem 50 is formed.

The interface of the wall portion 65 and the handlebar-engaging end 60 defines a bonding web 116. The bonding web 116, shown in FIG. 5, is an arcuate portion that is curved to closely match the handlebar 45. In addition, the bonding web 116 assures that the handlebar 45 is completely surrounded by the stem 55 when the steering assembly is complete. Completely surrounding the handlebar 45 increases the surface area of the molded joint, thus providing a stronger steering interface 30.

The handlebar 45 is also preferably formed from a composite material, such as a carbon/epoxy composite, with other materials also being suitable for use (e.g., plastics, metals, other composites, and the like). The handlebar 45 generally includes an attachment portion 120 (shown in FIG. 4) that facilitates the attachment of the handlebar 45 to the stem 50. As shown in FIG. 4, the attachment portion 120 has the same wall thickness 125 and the same outside diameter as the rest of the handlebar 45. The wall thickness 125 is less than what was required in prior handlebars because the clamping forces have been eliminated. In addition, the wall thickness 125 can be smaller than prior handlebar wall thicknesses as the portion of the stem 50 that extends around the handlebar attachment portion 120 provides additional strength and reinforcement. In some constructions, the wall thickness in the attachment portion 120 remains substantially the same as the wall thickness adjacent the attachment portion 120, but the outside diameter of the attachment portion 120 is reduced (as is the inside diameter) as compared to the adjacent portions of the handlebar 45. This construction provides a space to receive material that forms the stem 50. In still another construction, the attachment portion defines a first wall thickness, while the portion of the handlebar adjacent the attachment portion defines a second wall thickness that is greater than the first wall thickness. Again, this construction provides a space to receive material that forms the stem 50. As one of ordinary skill in the art will realize, the handlebar 45 may include many different wall thicknesses in several different areas depending on expected loading conditions and other design considerations.

While there are many different procedures available to manufacture the steering assembly 30, one procedure begins by manufacturing the handlebar 45. Prepreg lay-up material is cut and layered onto a pattern or in a mold to define the handlebar 45. Generally, the prepreg material is made of woven or unidirectional carbon fibers that are impregnated with an adhesive such as epoxy. The attachment portion 120 can include less prepreg material than prior handlebars since there are not any compressive stem clamp crush forces. Once the composite lay-up is positioned as desired, the handlebar 45 is heated under pressure to cure the adhesive. The handlebar 45 may be ground, sanded, or machined to complete the manufacture of the handlebar 45. Of course, one of ordinary skill in the art will realize there are many ways of manufacturing a composite handlebar. As such, the invention should not be limited to the method described.

A stem mold 135, shown in FIG. 6, is provided to accommodate the lay-up of the stem 50. The composite lay-up required to define the lower portion of the stem 50 is positioned and oriented as desired within the mold 135. Again, prepreg material (i.e., material impregnated with an adhesive such as epoxy) is preferred. Next, the completed handlebar 45 is positioned within the mold 135 such that the attachment portion 120 of the handlebar 45 rests on top of some of the prepreg material positioned to define the bottom of the stem 50. By positioning the material needed for the lower portion of the stem 50 before positioning the handlebar 45, it is possible to wrap the material around the attachment portion 120 of the handlebar 45 to better integrate the two components 45, 50. In most constructions, an inflatable air bladder (not shown) is also positioned within the interior space 115 of the stem 50.

Additional material, if needed, is positioned within the mold 135 and integrated with the lower portion material that is wrapped around the handlebar 45. Once all the materials are positioned as desired, the stem mold 135 is closed, the mold is heated, and the bladder is expanded to pressurize the prepreg material. The bladder pushes the materials against the inside of the mold 135 to achieve the desired shape of the stem 50. The assembly is then cured to form a single integrated part that includes both the stem 50 and the handlebar 45. Once cured, the handlebar 45 and the stem 50 cannot be separated from one another without destroying or damaging the handlebar 45 and/or the stem 50. The formed steering assembly 30 is then machined, sanded, or ground to form the apertures 90, the split 80, and any other features that need additional accuracy or smoothing.

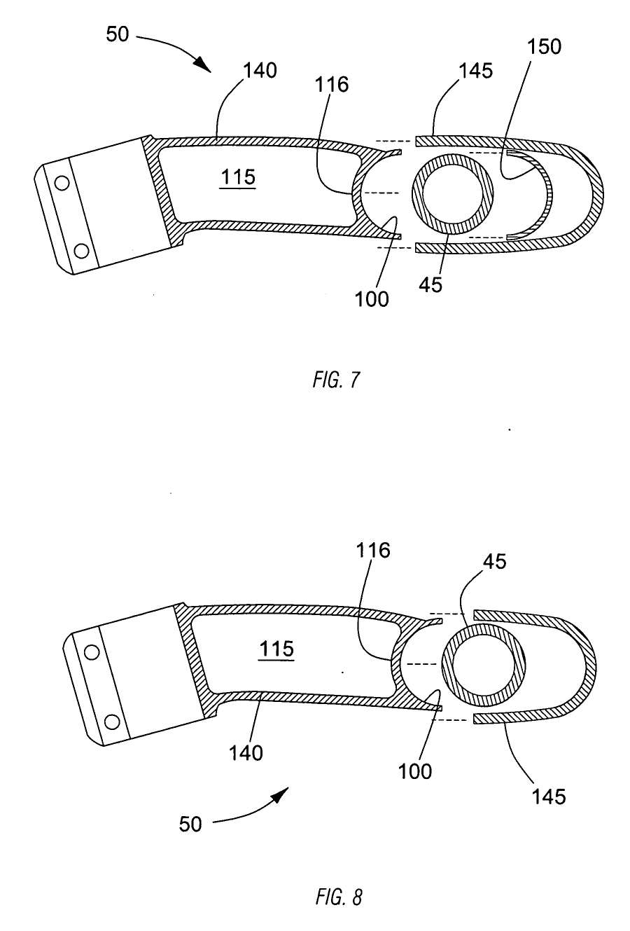

In another construction, illustrated in FIG. 7, the handlebar 45 is completely formed as it was in the previous example. The stem 50 is partially formed and cured such that it includes a complete inner cylindrical wall 100. The inner cylindrical wall 100 is then split along its largest diameter to separate the stem 50 into a stem portion 140 and a handlebar cover 150. The handlebar 45, the partial stem 140, and the handlebar cover 150 are then positioned adjacent one another and, in some constructions, bonded to one another using an adhesive such as epoxy. Additional prepreg material 145 is positioned to define a portion of the completed stem 50 and extend around the attachment portion 120 of the handlebar 45. The assembly is cured (e.g., in a mold) to complete the attachment of the handlebar 45 and the stem 50. The formed steering assembly 30 is then machined, sanded, or ground to form the apertures 90, the split 80, and any other features that need additional accuracy or smoothing.

In yet another construction illustrated in FIG. 8, the handlebar 45 is completely formed and cured and the stem 50 is partially formed and cured as was described with regard to FIG. 7. The cylindrical wall 100 is again split along its diameter to define the stem portion 140 and a small portion equivalent to the handlebar cover 150, which is discarded. The handlebar 45 is positioned adjacent the stem portion 140 and bonded to the stem portion 140. Additional prepreg material 145 wraps around the handlebar 45 and forms part of the completed stem 50. The entire assembly is then cured to complete the attachment of the handlebar 45 to the stem 50. The formed steering assembly 30 is then machined, sanded, or ground to form the apertures 90, the split 80, and any other features that need additional accuracy or smoothing.

The methods just described allow for the manufacture of a steering assembly 30 that includes a visible step 110 on either side of the stem 50 between the stem 50 and the handlebar 45. The steps 110 give the appearance that the handlebar 45 is a separate component, when in reality the two parts 45, 50 are actually integrally-formed into a single steering interface 30. The shape of the steps 110 can be tailored or changed to achieve many different aesthetic appearances or can be eliminated if desired.

Thus, the invention provides, among other things, a new and useful steering interface 30 for a bicycle 10. More particularly, the invention provides a new and useful composite steering interface 30 that includes a stem 50 and a handlebar 45 that are integrated into a single component that is lighter and stronger than the components it replaces, that cannot be incorrectly adjusted by the rider or end user, and that is suited for use with a bicycle 10. Various features and advantages of the invention are set forth in the following claims.

What is claimed is:

1. A steering interface for a bicycle including a front fork, the steering interface comprising:
a handlebar formed as a separate component; and
a stem including an attachment portion and a bar-receiving portion, the attachment portion adapted to engage the front fork to connect the stem to the bicycle, at least a portion of the bar-receiving portion being formed around a portion of the handlebar such that the handlebar and the stem are integrated into a single component.

2. The steering interface of claim 1, wherein the bar-receiving portion includes a substantially cylindrical wall that defines a tube space.

3. The steering interface of claim 2, wherein a portion of the handlebar is disposed within the tube space.

4. The steering interface of claim 1, wherein the bar-receiving portion cooperates with the handlebar to define a step.

5. The steering interface of claim 1, wherein the bar-receiving portion cooperates with the handlebar to define a first step on a first side of the bar-receiving portion and a second step on a second side of the bar-receiving portion.

6. The steering interface of claim 1, wherein the stem is at least partially formed from a composite material.

7. The steering interface of claim 6, wherein the handlebar is at least partially formed from a composite material.

8. The steering interface of claim 1, wherein the bar-receiving portion includes a bonding web such that the bar-receiving portion completely surrounds a portion of the handlebar.

9. A method of manufacturing a steering interface comprising:
forming a handlebar;
arranging at least one layer of material to partially define a stem;
arranging the handlebar and the stem adjacent one another; and
completing the formation of the stem such that the stem and the handlebar are integrated into a single component.

10. The method of claim 9, wherein forming a handlebar includes positioning a composite layer.

11. The method of claim 10, wherein forming a handlebar further includes curing the composite layer.

12. The method of claim 9, further comprising positioning the handlebar at least partially within a stem mold.

13. The method of claim 9, wherein the completing step includes positioning at least one layer of a composite material such that the material at least partially defines a portion of the stem and at least partially surrounds a portion of the handlebar.

14. The method of claim 13, further comprising defining a first step and a second step between the at least one layer and the handlebar.

15. The method of claim 9, further comprising curing the stem to bond the stem to the handlebar.

16. The steering interface of claim 9, further comprising arranging at least one layer of material to define a bonding web.

17. A method of manufacturing a steering interface comprising:
forming a handlebar;
curing the handlebar;
at least partially forming a stem;
curing the at least partially formed stem;
positioning the handlebar adjacent the stem; and
bonding the stem to the handlebar to form a single integrated component.

18. The method of claim 17, wherein bonding the stem includes arranging a layer of material such that the layer covers at least a portion of the stem and extends around a portion of the handlebar and curing the layer of material.

19. The method of claim 17, wherein the layer of material cooperates with the handlebar to define a step between the stem and the handlebar.

20. The method of claim 17, wherein forming a handlebar includes positioning at least one layer of a composite material.

21. The method of claim 17, wherein forming a stem includes positioning at least one layer of a composite material.

22. The method of claim 17, further comprising forming a substantially cylindrical wall portion that completely surrounds a portion of the handlebar.
